(19) United States
(12) Patent Application Publication
(10) Pub. No.: US 2020/0328662 A1
(43) Pub. Date: Oct. 15, 2020

(54) WINDING MACHINE

(71) Applicant: SMZ WICKEL- UND MONTAGETECHNIK AG, Würenlos (CH)

(72) Inventors: Daniel RISSI, Seewis (CH); Peter ULRICH, Rudolfstetten (CH)

(73) Assignee: SMZ WICKEL- UND MONTAGETECHNIK AG, Würenlos (CH)

(21) Appl. No.: 16/096,330

(22) PCT Filed: Apr. 12, 2017
(86) PCT No.: PCT/EP2017/058847

§ 371 Date: Oct. 25, 2018

(30) Foreign Application Priority Data
Apr. 27, 2016 (EP) 16167285.2

(51) Int. Cl. H02K 15/08

(52) U.S. Cl. CPC H02K 15/08

(57) ABSTRACT

A winding machine (1) for winding coils (4), having at least one coil-body receptacle (2) providing a receiving space (5) for coil bodies to be wound and at least one winding-material feed (3) being configured to feed winding material into the receiving space (5). The at least one coil-body receptacle (2) comprises at least a first and a second receiving unit, wherein, in a first setting, using the first receiving unit, the winding machine (1) allows winding in accordance with a first winding technique and wherein, in a second setting, using the second receiving unit, the winding machine (1) allows winding in accordance with a second winding technique different from the first winding technique. The first and second winding techniques are selected from the group of winding techniques consisting of the coil-winding technique, the conventional needle-winding technique, the linear winding technique and the flyer-winding technique.

### TECHNICAL FIELD

The present invention relates to the field of winding machines, in particular wire-winding machines, for winding individual coils or coil arrangements, for example for laboratory operations or product development or for pilot lot or small lot production.

### PRIOR ART

Winding machines for different winding techniques are known from the prior art. In general, all devices which can implement a winding method have a coil-former receptacle, in which a coil former to be wound is received in a receiving space, and a winding-material 15 feed with which winding material can be fed into the receiving space. Known winding techniques are, for example, the coil winding technique, the needle winding technique, wherein the conventional needle winding technique and the linear winding technique both fall under the needle winding technique, and the flyer winding technique.

These winding techniques as understood herein are described in more detail with 20 reference to figures together with the preferred embodiments.

The machines known from the prior art are each configured especially for a specific winding method and optimized accordingly for this, for example in terms of production time or costs. It is therefore not intended or not possible for a machine designed for one method to be used in another method.

### SUMMARY OF THE INVENTION

It is therefore an object of the present invention to provide a winding machine which can be used for different winding methods.

This object is achieved by a winding machine according to the invention having the 30 features of claim 1.

A winding machine according to the invention, in particular a wire-winding machine, for winding at least one coil has a machine stand having at least one coil-former receptacle, wherein the at least one coil-former receptacle provides a receiving space for at least one coil former to be wound. The winding machine furthermore has at least one winding-material feed, wherein the at least one winding-material feed is designed to feed winding material into the receiving space. The at least one coil-former receptacle comprises a set of at least one first receiving unit and at least one second receiving unit, wherein, in a first setting, using the first receiving unit, the winding machine allows winding of the at least one coil former to be wound in accordance with a first winding technique, and wherein, in a second setting, using the second receiving unit, the winding machine allows winding of the at least one coil former to be wound in accordance with a second winding technique which is different from the first winding technique. The first and second winding technique are selected from the group of winding techniques comprising the coil winding technique, the conventional needle winding technique, the linear winding technique and the flyer winding technique.

The at least one coil-former receptacle can comprise for example two, three, four, five, six, seven, eight, nine, ten or more of such coil-former receptacles, which are arranged adjacent to one another.

Since each coil-former receptacle comprises sets of receiving units, these sets are interchangeable as desired. Since each set is suitable for implementing a particular winding method, another winding method can be implemented depending on the set used. The same sets of receiving units are preferably used on all coil-former receptacles to enable parallel production using identical winding methods. Alternatively, different sets of receiving units can be used on different coil-former receptacles. This enables parallel production using different winding methods.

The interchangeability of the different sets of receiving units is advantageous in that the winding machine can be converted from one winding method to the other. This is advantageous for laboratory operations or in product development, where individual coils, pilot lots or small lots are produced, for example. The focus of such a winding machine is on versatility and not on producing large quantities.

The first receiving unit preferably has a first receiving carrier and a first receptacle arranged on the first receiving carrier for receiving a first coil former of the at least one coil former to be wound, whereby the first coil former can be wound in accordance with the first winding technique.

For example, the first receiving carrier is a plate on which the coil formers to be wound can be received directly or by means of first receptacles arranged on the said plate. For example, the first receptacle can comprise a rotating mechanism which allows the automatic rotation of the coil former arranged thereon. For example, one, two, three, four or more of such first receptacles can be arranged adjacent to one another on the first receiving carrier.

The second receiving unit preferably has a second receiving carrier and a second receptacle arranged on the second receiving carrier for receiving a second coil former of the at least one coil former to be wound, whereby the second coil former can be wound in accordance with the second winding technique.

For example, the second receiving carrier is a plate on which the coil formers to be wound can be received directly or by means of second receptacles arranged on the said plate. For example, the second receptacle can allow a plurality of coil formers to be wound to be received at the same time. One, two, three, four or more of such second receptacles can be arranged adjacent to one another on the second receiving carrier.

For example, the first receiving unit allows the implementation of the first coil winding technique and the second receiving unit allows the implementation of the conventional needle winding technique, the linear winding technique or the flyer winding technique.

In a preferable embodiment, the at least one winding-material feed has a set of at least one first feed unit and a second feed unit, wherein the winding machine is designed in such a way that, in the first setting of the winding machine, the first feed unit allows the winding of the at least one coil former in accordance with the first winding technique and, in the second setting of the winding machine, the second feed unit allows the winding of the at least one coil former in accordance with the second winding technique.

The at least one winding-material feed can comprise for example two, three, four, five, six, seven, eight, nine, ten or more of such winding-material feeds, which are arranged adjacent to one another.

Since each winding-material feed comprises sets of feed units, these sets are interchangeable as required. Since each set is suitable for implementing a particular winding method, another winding method can be implemented depending on the set used. The same sets of feed units are preferably used on all winding-material feeds to enable parallel production using identical winding methods. Alternatively, different sets of feed units can be used on different winding-material feeds. This enables parallel production using different winding methods.

The interchangeability of the different sets of feed units allows simple and rapid conversion of the winding machine, which simplifies the implementation of different winding methods.

The first feed unit preferably has a first feed carrier and a first feed arranged on the first feed carrier for feeding winding material, whereby the first coil former can be wound in accordance with the first winding technique. The second feed unit preferably has a second feed carrier and a second feed arranged on the second feed carrier for feeding winding material, whereby the second coil former can be wound in accordance with the second winding technique.

For example, the first feed unit allows the implementation of the coil winding technique or the conventional needle winding technique and the second feed unit allows the implementation of the linear winding technique or the flyer winding technique.

The at least one coil-former receptacle is preferably non-releasably and/or non-displaceably and/or non-swivelably and/or non-rotatably arranged on the machine stand or the at least one coil-former receptacle is preferably releasably and/or displaceably and/or swivelably and/or rotatably arranged on the machine stand.

The machine stand preferably has a table area, wherein the table area is designed for arranging the at least one coil-former receptacle. The machine stand preferably has a gantry area, wherein the gantry area is designed for arranging the at least one winding-material feed.

In a preferable embodiment, the gantry area has a gantry, wherein the gantry is arranged on the machine stand such that it is non-releasable and/or non-displaceable and/or non-swivelable and/or non-rotatable relative thereto, and wherein at least one slide is arranged on the gantry such that it is linearly displaceable in a first direction relative to the machine stand.

The gantry allows a large displacement range in the first direction without thereby adversely affecting the winding space.

The at least one coil-former receptacle is preferably arranged on the machine stand such that it is displaceable relative to a second direction relative to the said machine stand, wherein the second direction is formed at an angle, preferably a right angle, relative to the first direction.

Owing to the displaceability of the coil-former receptacle, the gantry does not have to be designed to be displaceable, which allows a simpler construction and simpler feeding of the winding material.

The at least one winding-material feed is preferably non-releasably and/or non-displaceably and/or non-swivelably and/or non-rotatably arranged on the machine stand or wherein the at least one winding-material feed is releasably and/or displaceably and/or swivelably and/or rotatably arranged on the machine stand.

In a preferable embodiment, the at least one winding-material feed is arranged on the at least one slide.

The first receptacle and/or the second receptacle are/is preferably designed in such a way that it allows a rotation of the at least one coil former to be wound about an axis which is aligned in a third direction relative to the machine stand, wherein the third direction is formed at an angle, preferably a right angle, relative to the first direction and the second direction.

In a preferred embodiment, the at least one coil-former receptacle is designed in such a way that one, two, three, four, five, six, seven, eight, nine, ten, eleven, twelve or more coil formers to be wound can be received at the same time.

The at least one winding-material feed is preferably designed in such a way that one, two three, four, five, six, seven, eight, nine, ten, eleven, twelve or more coil formers to be wound can be wound at the same time. It is advantageous if the number of winding-material feeds corresponds to the number of coil-former receptacles.

Receiving a plurality of coil formers to be wound at the same time and feeding winding material to a plurality of coil formers to be wound at the same time increases the productivity of the winding machine and allows the testing of conditions such as those which prevail for example in series production.

The first feed is preferably displaceable in the first direction and swivelable or rotatable relative to the third direction and wherein the first receptacle is displaceable relative to the second direction and is swivelable or rotatable relative to the third direction.

This embodiment allows the implementation of the coil winding technique or the conventional needle winding technique, for example.

The second feed is preferably displaceable in the first direction or the second feed is displaceable in the first direction and swivelable or rotatable relative to the third direction and the second receptacle is displaceable relative to the second direction. This allows the implementation of the linear winding technique, for example.

Winding material is for example wire, for example copper or aluminum wire with circular or angular cross sections, which is applied uncoated or coated to a coil former. The coating is made from plastics material, for example. Common wires with different diameters can be used.

The coil winding technique, the conventional needle winding technique, the linear winding technique and the flyer winding technique as understood herein are described with the aid of figures.

Further embodiments are described in the dependent claims.

### BRIEF DESCRIPTION OF THE DRAWINGS

Preferred embodiments of the invention are described below with reference to the drawings, which merely serve for explanation and should not be interpreted as restrictive.

The drawings show:

FIG. 1 a perspective view of a winding machine according to the invention;

FIG. 2 a lateral sectional view of the winding machine of FIG. 1 without a cover;

FIG. 3 a front sectional view of the winding machine of FIG. 1 without a cover;

FIG. 4 a perspective illustration of the coil winding technique;

FIG. 5 a perspective illustration of the conventional needle winding technique;

FIG. 6 a perspective illustration of the linear winding technique;

FIG. 7 a perspective illustration of the flyer winding technique

FIG. 8 a perspective partial view of the winding machine of FIG. 1 with a configuration for the conventional needle winding technique;

FIG. 9 a perspective view of the feed unit and the auxiliary unit of FIG. 8;

FIG. 10 a perspective partial view of the winding machine of FIG. 1 with a configuration for the linear winding technique for an individual coil former to be wound;

FIG. 11 a perspective view of the feed unit of FIG. 10;

FIG. 12 a perspective view of the feed unit of FIG. 11 with an alternative drive;

FIG. 13 a perspective partial view of the winding machine of FIG. 1 with a configuration for the linear winding technique for a plurality of coil formers to be wound at the same time;

FIG. 14 a perspective view of the feed unit of FIG. 13; and

FIG. 15 a perspective view of an auxiliary unit, for example a wire catching and cutting unit.

### DESCRIPTION OF PREFERRED EMBODIMENTS

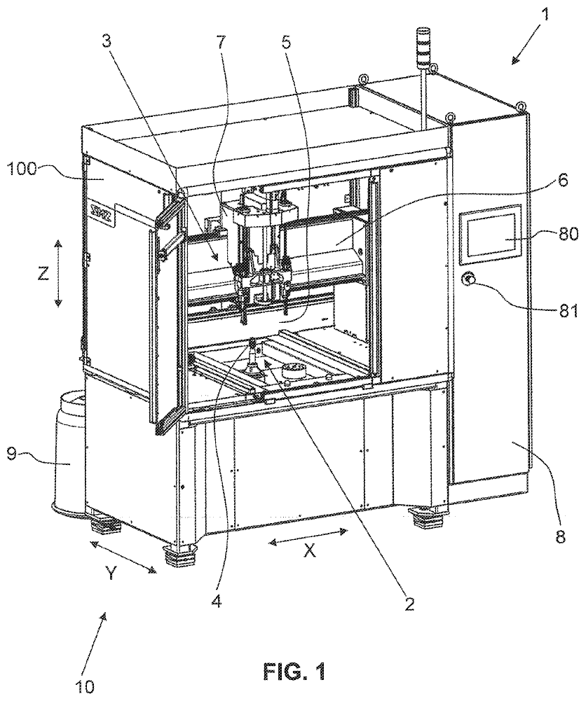

FIG. 1 shows a perspective view of a winding machine 1 according to the invention. The winding machine 1 substantially has a machine stand 10 having a coil-former receptacle 2 and a winding-material feed 3, wherein the coil-former receptacle 2 is designed to provide a coil former 41, 42 of a coil 4 to be wound in a receiving space 5, and wherein the winding-material feed 3 is designed to feed winding material 90 to the receiving space 5. A gantry 6, on which a slide 7 is arranged such that it is movable in a first direction X, is arranged on the machine stand 10. The winding machine 1 furthermore has a control cabinet 8 for operating and controlling the winding machine 1. An input unit 80 in the form of a touchscreen is provided on the front side of the control cabinet 8. An emergency off button 81 is furthermore provided in the region of the input unit 80. The control cabinet 8 houses a system control. The special feature of the system control is that it is suitable for implementing each of the winding methods mentioned herein. For example, after changing-over the machine, the control can be reset from the control of one winding method to the control functions of a different winding method in a simple manner (e.g. by pressing a button or a region on the touch screen). Alternatively, the sets of receiving units 21, 22 and the sets of feed units 31, 32 can be provided with sensor-recognizable features (e.g. RFID) which can be identified by the control using the corresponding recognition sensors. The control can then switch automatically to the program of the corresponding winding method.

The control cabinet 8 is arranged at the side of the machine stand 10. The areas of the coil-former receptacle 2, the winding-material feed 3 and therefore the area of the receiving space 5 can be protected by a cover 100 to prevent external intervention during operation. The cover 100 has a closable opening in a front area facing an operator. An outwardly opened swing door is illustrated on the left side of the opening as seen in the viewing direction of FIG. 1 and a swing/sliding door which is pushed to the side is illustrated on the right hand side of the opening. The sliding/sliding door has an outer frame which is arranged on the machine stand 10 such that it can swivel relative thereto on its right side about a vertical axis of rotation. A sliding door which is displaceable to the right is guided in this swivelable frame.

The winding machine 1 has substantially three movement directions X, Y, Z. A first direction X (X axis), in which the slide 7 is displaceable on the gantry 6, a second direction Y (Y axis), which is substantially perpendicular to the first direction X. and a third direction Z (Z axis), which is substantially perpendicular to the first direction X and the second direction Y. In this exemplary embodiment, the first direction X and the second direction Y are aligned horizontally and the third direction Z is aligned vertically.

The winding machine 1 furthermore has a winding-material store 9 (wire barrel) for winding material (wire). The winding-material store 9 can be arranged adjacent to the winding machine 1 as illustrated, although it can also be arranged in the winding machine 1. A plurality of winding-material stores 9 for the same or different winding material 90 can also be provided. The winding material 90 can differ in terms of the material, or the coating, the dimensions of the cross section (e.g. size of the diameter) or the cross-sectional shape (circle, oval, polygon).

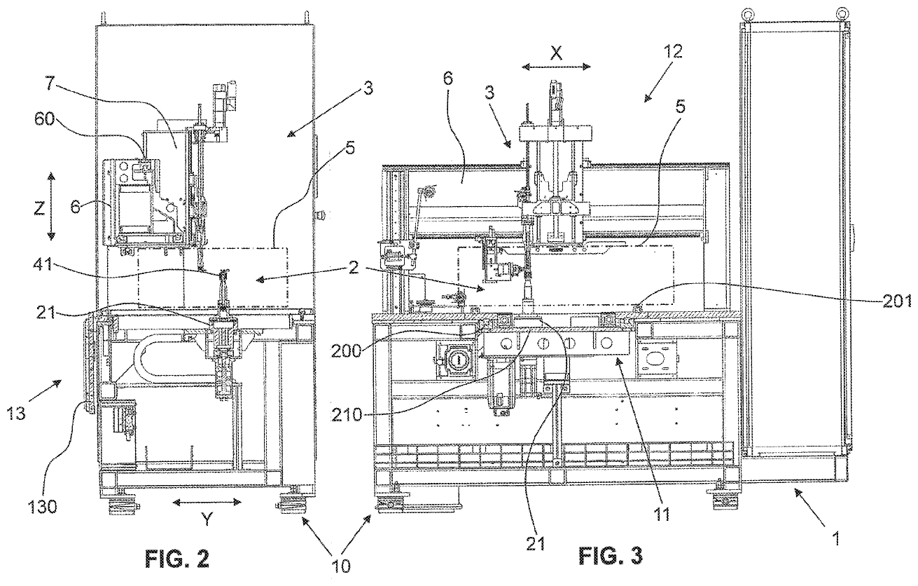

FIG. 2 shows a lateral sectional view of the winding machine 1 of FIG. 1 without a cover 100 and FIG. 3 shows a front sectional view of the winding machine of FIG. 1 without a cover 100. The machine stand 10 has a frame structure. A first receiving unit 21 is arranged such that it is displaceable in a table area 11 in the second direction Y in the machine stand 10. In the illustrated embodiment, the first receiving unit 21 has a first receiving carrier 210 in the form of a table, which is arranged such that it is displaceable in the second direction Y by means of first rails 200 on the machine stand 10. A first coil former 41 can be arranged on the first receiving unit 21, which coil former is movable in the second direction Y by the first receiving unit 21 in the receiving space 5 and which is rotatable about the Z axis. The first rails 200 for guiding the first receiving unit 21 are mounted in the interior of the machine stand 10.

The gantry 6 is arranged on the machine stand 10 in the rear area thereof, which is remote from the user, i.e. in a gantry area 12. In this exemplary embodiment, the gantry 6 is non-displaceably arranged on the machine stand 10. Alternatively, the gantry 6 can be displaceably arranged on the machine stand 10. For example, the gantry 6 can be displaceable relative to the second direction, i.e. in the direction of the Y axis. The slide 7 is arranged on the gantry 6 such that it is displaceable in the first direction X by means of gantry rails 60. The displacement of the slide 7 takes place by means of a drive system, for example a spindle drive. However, other drive systems such as belt or chain drives or other conventional linear drive systems can also be used. The displacement of the first receiving unit 21 in the direction of the Y axis takes place by means of a spindle drive. However, other conventional drive systems can likewise be used. The rotation of the first receiving unit 21 about the Z axis takes place by means of an electric drive. Other conventional drives can likewise be used.

A parking region 13 with a swivel table 130 is located at a spacing from the receiving space 5 in the rear region of the machine stand 10. The swivel table 130 is arranged on the rear upper edge of the frame structure of the machine stand 10 such that it is swivelable relative to the X axis. Supporting elements in the form of springs or counterweights can be provided to promote the swivel movement of the table 130. Alternatively, a swivel drive can be provided. If the first receiving unit 21 is to be used, the second receiving unit 22 is removed from the area of the receiving space 5. To this end, the second receiving carrier 220 can be separated from its drive and its rails and can be deposited adjacent to the machine. The above-mentioned swivel table 130 represents a more practical variant. This allows that the second receiving carrier 220 simply has to be separated from its drive, since, after the separation, the second receiving carrier 220 can be slid onto the folded-up swivel table 130. If the folded-up swivel table 130 with the second receiving carrier 220 arranged thereon does not disturb the operation of the system, it can be left in this position. Alternatively, the swivel table 130 together with the second receiving carrier 220 can be folded downwards.

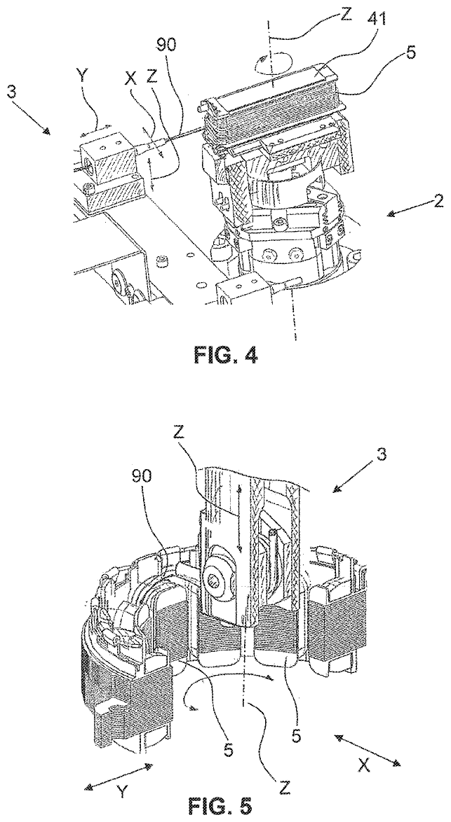

FIG. 4 shows a perspective illustration of the coil winding technique. In the coil winding technique, the coil-former receptacle 2 is mounted such that it is rotatable relative to the Z axis and the coil center axis of the coil former 41 to be wound is aligned substantially with the axis of rotation of the coil former receptacle 2, preferably co-linearly. The winding-material feed 3 is movable at least in a direction parallel to the axis of rotation of the receptacle Z. Additionally, the winding-material feed 3 can be movable in a horizontal direction X perpendicular to the Z axis and/or a relative movement between the coil-former receptacle 2 and the winding-material feed 3 can be provided in the direction of the Y axis, wherein either the coil-former receptacle 2 and/or the winding-material feed 3 is designed to be displaceable. When the winding material 90 is applied to the coil former 41 to be wound, the winding-material feed 3 is moved in such a way that the winding material 90 can be applied in layers substantially tangentially to the winding material 90 already applied. It goes without saying that the winding-material feed can also be otherwise aligned, whereby the corresponding axes are simply swapped.

There are two different techniques for the needle winding technique: the conventional needle winding technique and the linear winding technique.

FIG. 5 shows a perspective illustration of the conventional needle winding technique. In the conventional needle winding technique, the coil formers of a rotor or stator to be wound are mounted in a rotatable coil former receptacle (not illustrated here), wherein the center axis of the rotor or stator is aligned with the axis of rotation of the receptacle, preferably co-linearly. The winding-material feed 3 is movable at least in a direction parallel to the axis of rotation of the receptacle Z and in a direction X perpendicular thereto. The winding-material feed 3 has a first feed with a needle, which can be brought between two adjacent coil formers to be wound. During the application of the winding material to one of the coil formers to be wound, the movements of the coil-former receptacle (rotation about the Z axis: back and forth; translation along the Y axis forwards and back) and the winding-material feed (translation along the Z axis: up and down) are matched to one another in such a way that, by means of the needle, the winding material 90 can be applied in layers to the winding material already applied. Alternatively, the needle can be designed to be swivelable so that it can be brought from a substantially horizontal alignment into a substantially vertical alignment and vice versa.

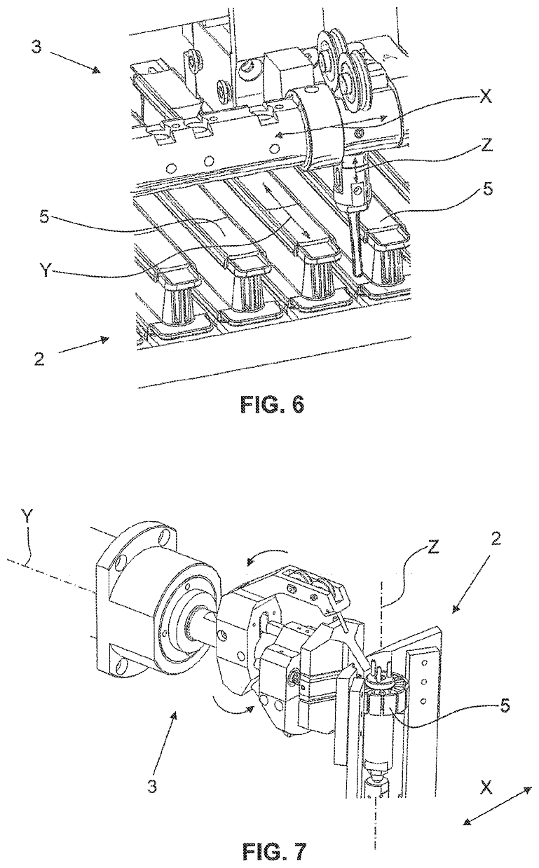

FIG. 6 shows a perspective illustration of the linear winding technique. In the linear winding technique, the rotor/stator is separated and the coil formers 42 to be wound are rolled apart and placed adjacent to one another on a plane. This offers the advantage that the spacing between two adjacent coil formers 42 to be wound is increased compared to the rolled-together form of use, which allows the use of a needle with a larger cross section, thereby enabling winding material with a larger cross section to be used.

In the linear winding technique, the coil formers 41 to be wound are mounted individually or together on a displaceable coil-former receptacle 2, wherein the axis of the longitudinal extent of the coil former(s) to be wound is aligned with the movement axis (Y axis) of the coil-former receptacle 2, preferably co-linearly. The winding-material feed 3 is movable at least in a direction perpendicular to the movement axis of the receptacle (X axis) and in a direction (Z axis) perpendicular thereto. The winding-material feed 3 has a needle, which can be brought between two adjacent coil formers to be wound. During the application of the winding material to one of the coil formers to be wound, the movements of the coil-former receptacle 2 (translation along the Y axis: forwards and back) and the winding-material feed (translation along the X-axis: back and forth; translation along the Z axis: up and down) are matched to one another in such a way that, by means of the needle, the winding material can be applied in layers to the winding material already applied.

FIG. 7 shows a perspective illustration of the flyer winding technique. In the flyer winding technique, the coil former 5 to be wound is rigidly mounted during winding, wherein the coil center axis of the coil former to be wound, in the illustrated embodiment an individual tooth of a rotor, is aligned with the movement direction Y of the winding-material feed 3, preferably co-linearly. The winding-material feed is movable at least in the direction of the coil center axis Y and can execute a rotation about this axis Y. During winding, the winding-material feed 3 rotates about the coil center axis. Additionally, the winding-material feed 3 can move simultaneously along the coil center axis Y. A plurality of coil formers to be wound, as in the case of the rotor illustrated, can be arranged on a rotatable coil-former receptacle. After a coil has been wound, the coil-former receptacle is rotated through one pitch so that the next coil former can be wound.

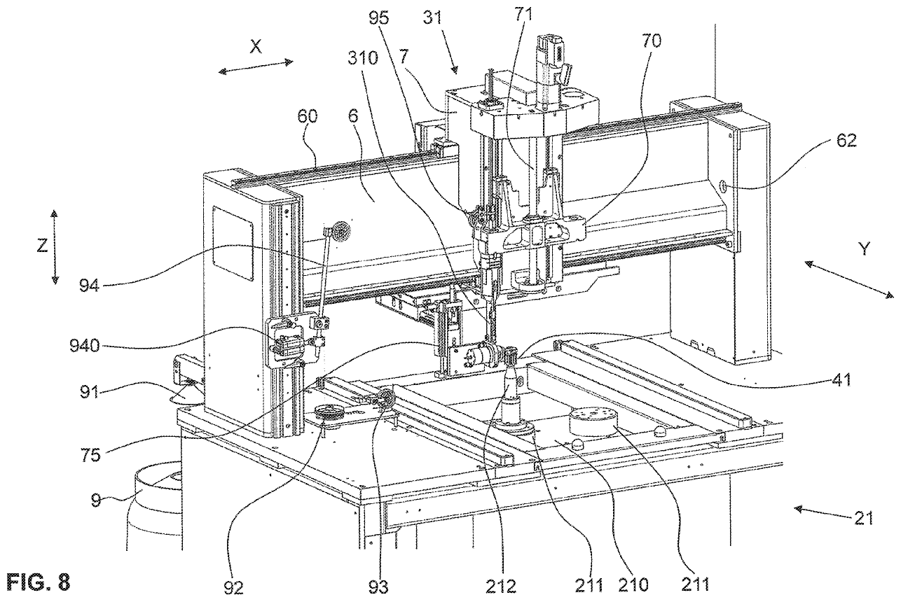

FIG. 8 shows a perspective partial view of the winding machine of FIG. 1 with a configuration for the conventional needle winding technique. The first receiving unit 21 is installed in the table area 11. The second receiving unit 22 in this configuration is located in the parking region 13, so as to not adversely affect the receiving space 5, i.e. so as to not hinder the winding. The first receiving unit 21 has a first receiving carrier 210, which is displaceable in the second direction (Y axis) and is in the form of a table which is displaceable on first rails 200 (not illustrated) and on which, in this embodiment, two first receptacles 211 are arranged adjacent to one another on the table 210, wherein one of the two receptacles 211, in this case the left one, has an adapter 212 for receiving a first coil former 41 to be wound. The two first receptacles 211 are designed to be rotatable about the Z axis.

At the side of the feed space 5, conventional elements for feeding winding material are arranged on the machine stand 10 in the table area 11. The winding material 90 is guided from the winding-material store 9 (also referred to as wire barrel) via a deflection cone 91 to a brake roller 92 and, from this, via a sensor roller 93 and a compensation arm 94 with a deflection roller to the first feed unit 31. The compensation arm 94 is arranged laterally on the gantry 6. The compensation arm 94 is pre-tensioned by a spring element 940, whereby a tensioning force is exerted on the winding material 90. During winding, the compensation arm 94 can compensate differences in the feed rate of the winding material in that the arm is deflected at a higher rate, in this case downwards, and wherein the arm is swiveled upwards when the rate decreases. It is thus possible to ensure that the winding material is conveyed from the winding-material store 9 as evenly as possible.

Alternatively, the compensation arm can also be arranged on the machine stand 10, like the brake roller 92 and the sensor roller 93 in this exemplary embodiment. The brake roller 92, together with the compensation arm 94, ensures that sufficient tension is exerted on the wire to be wound (winding material) 90, i.e. that the winding wire 90 is sufficiently tensioned. The sensor roller 93 determines whether a wire is being guided by the roller. If this is not the case, a corresponding signal is transmitted to the system control. The winding process is interrupted and/or an acoustic and/or optical warning signal is generated.

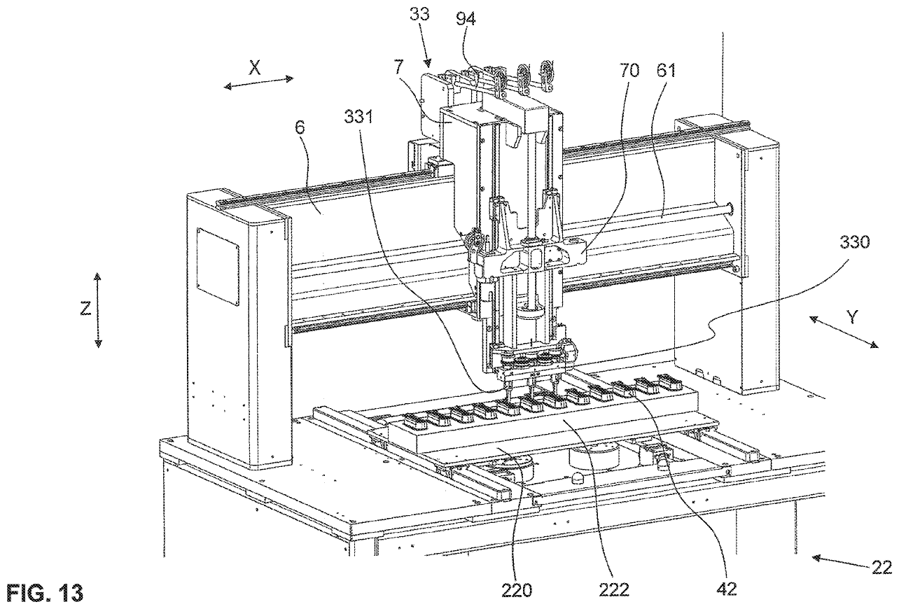

The first feed unit 31 is arranged in the gantry region 12. A slide 7 is arranged on the gantry 6 such that it is horizontally displaceable (X axis) by means of gantry rails 60 and a drive. In the illustrated embodiment, the horizontal displacement of the slide 7 is not required for the winding process and is therefore not illustrated. However, as illustrated in FIG. 13, a drive 61 for the horizontal axis X can be provided, for example in the form of a spindle drive. Openings 62 for the spindle are provided on the gantry 6. Alternatively, a belt or chain drive or another known linear drive can also be used.

A vertical slide 70 is arranged on the slide 7 such that it is vertically (Z axis) displaceable by means of rails and a drive system 71, 72. The drive system 71, 72 for the vertical displacement is a spindle drive in this embodiment; however, other drive systems can likewise be used. A first feed carrier 310 with a first feed 311 (a so-called needle) is arranged on the side of the vertical slide 70 which is directed towards the table area 11. These first feeds 311 are known from the prior art and direct a winding material 90 out of the vertical and into the horizontal and allow winding material to be applied to the coil former to be wound. In the illustrated example, this is a rotor of an electric motor with outer coils, which is to be wound using the conventional needle winding technique.

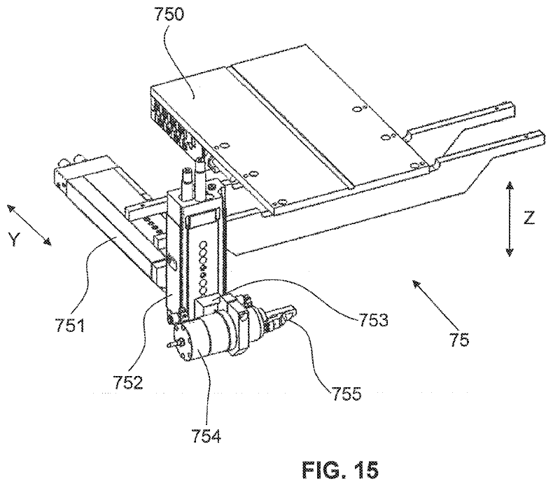

In FIG. 8, an auxiliary unit 75 is furthermore shown, which serves for holding or catching and cutting the winding material 90. This auxiliary unit 75 is described in detail in conjunction with FIG. 15.

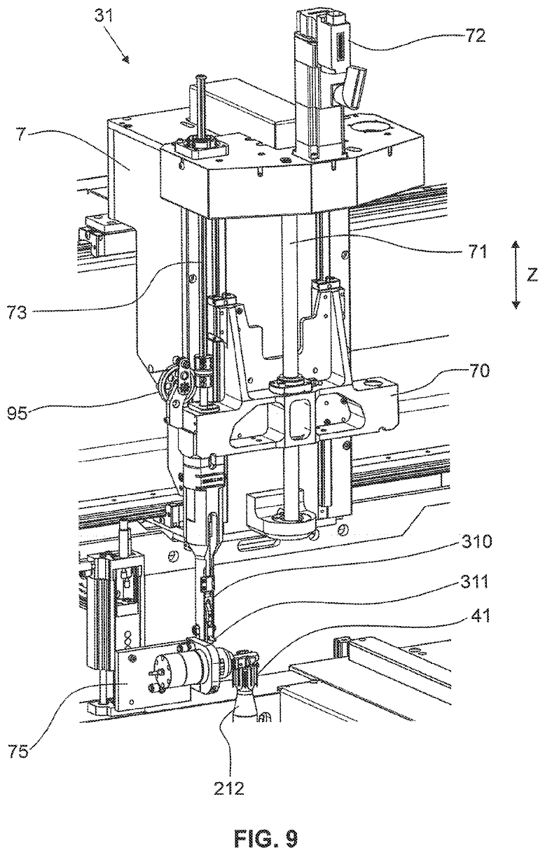

FIG. 9 shows a perspective view of the feed unit 31 of FIG. 8. The general construction has already been described in conjunction with FIG. 8. The vertical slide 70 is displaceable by a spindle 71, which is driven by an electric motor 72. The needle 311 can be swiveled from the horizontal into the vertical, and vice versa, by a mechanism in the first feed carrier 310. A profiled shaft 73 transmits a drive torque from a drive (not illustrated) of the slide 7 to the mechanism in the first feed carrier 310 and this transmits it further to the first feed 311. The profiled shaft 73 enables a precise force transmission in any position of the vertical slide 70.

A further deflection roller 95 is arranged on the vertical slide 70 of the first feed unit 31, which deflection roller deflects the winding material from the horizontal into the vertical and feeds it to the first feed carrier 310.

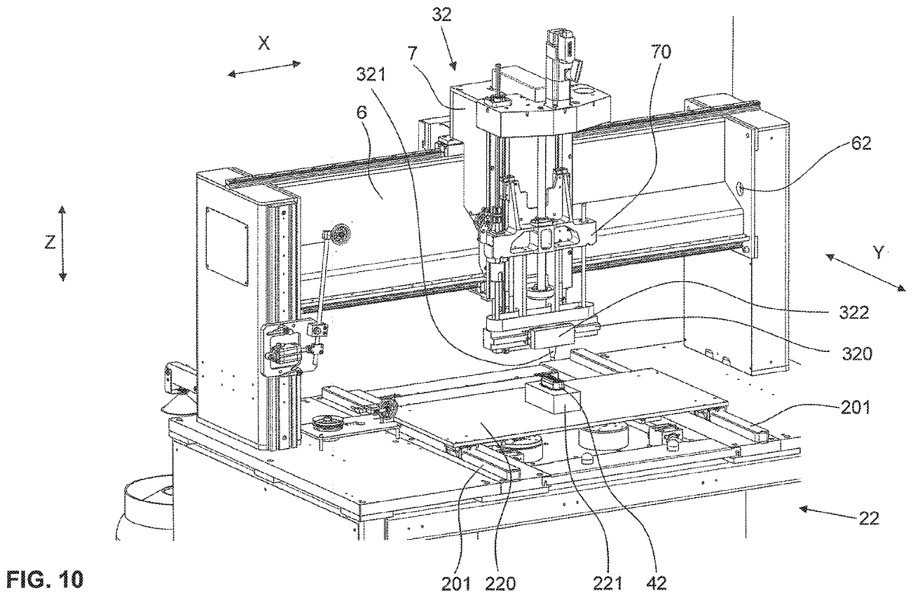

FIG. 10 shows a perspective partial view of the winding machine 1 of FIG. 1 with a configuration for the linear winding technique for an individual coil former 42 to be wound. In the illustrated exemplary embodiment, the second coil former 42 to be wound is an individual tooth of an electric motor. The second receiving unit 22 is installed in the table area 11. The second receiving unit 22 has a second receiving carrier 220, which is displaceable in the second direction (Y axis) and is in the form of a table which is displaceable on second rails 201, wherein a second receptacle 221 is arranged on the table 220 in this embodiment. The second rails 201 for guiding the second receiving unit 21 are mounted on the machine stand 10.

The second feed unit 32 is arranged in the gantry region 12. A second feed carrier 320 with a second feed 321 with a needle is arranged on the vertical slide 70 on the side directed towards the table area 11. This second feed 321 is known from the prior art.

In the illustrated embodiment, the horizontal displacement of the slide 7 is not required for the winding process and is therefore not illustrated. However, as illustrated in FIG. 13, a drive 61 for the horizontal axis X can be provided, for example in the form of a spindle drive. The horizontal drive of the slide 7 allows flexible positioning of the second receptacle 221, for example, and therefore of the coil former 42 to be wound. Openings 62 for the spindle are provided on the gantry 6. Alternatively, a belt or chain drive or another known linear drive can also be used.

In this embodiment, the second feed carrier 320 is arranged on the vertical slide 70, wherein the second feed carrier 320 has a horizontal slide 322 (second X axis). The horizontal drive is implemented by means of a belt drive. If a drive for the X axis of the slide 322 is provided, the large slow displacements in the first direction X (first X axis), for example when setting up the machine or when changing to a further coil former to be wound, can be executed by the slide 7 and the small rapid displacements in the first direction X (second X axis) can be executed by the horizontal slide 322. This is advantageous in that the large mass of the entire second feed unit 32 with the slide 7, vertical slide 70 and horizontal slide 322 is moved by the robust horizontal drive 61 and the small mass of the horizontal slide 322 with the second feed 321 can be moved by a smaller drive. As a result of the fact that smaller masses have to be moved, a smaller, less robust structure is possible, since the acceleration forces which result from the movements and act on the structure are lower.

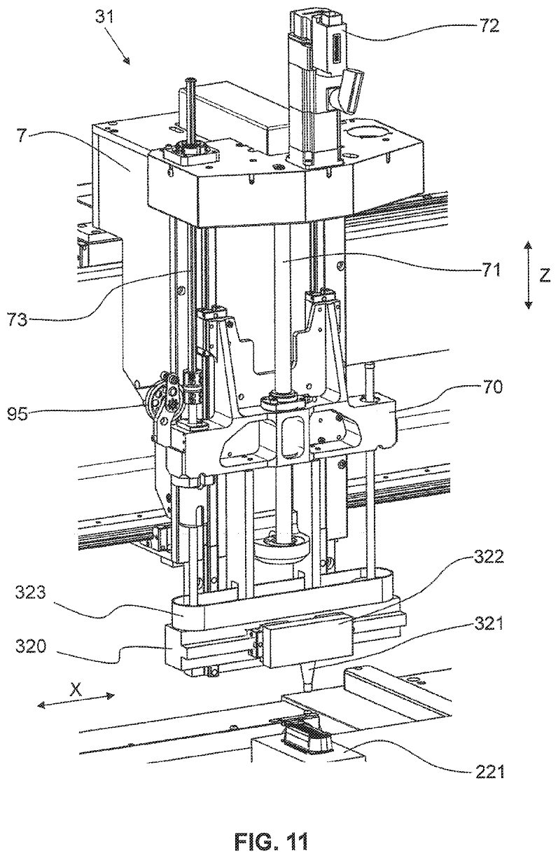

FIG. 11 shows a perspective view of the feed unit of FIG. 10. The second feed carrier 320 with the rail-guided horizontal slide 322, on which a needle 321 for feeding the winding material is arranged, is arranged on the vertical slide 70. The displacement of the horizontal slide 232 (second X axis) is effected by a belt drive 323. The profiled shaft 73 transmits a drive torque from a drive (not illustrated) of the slide 7 to the belt drive 323.

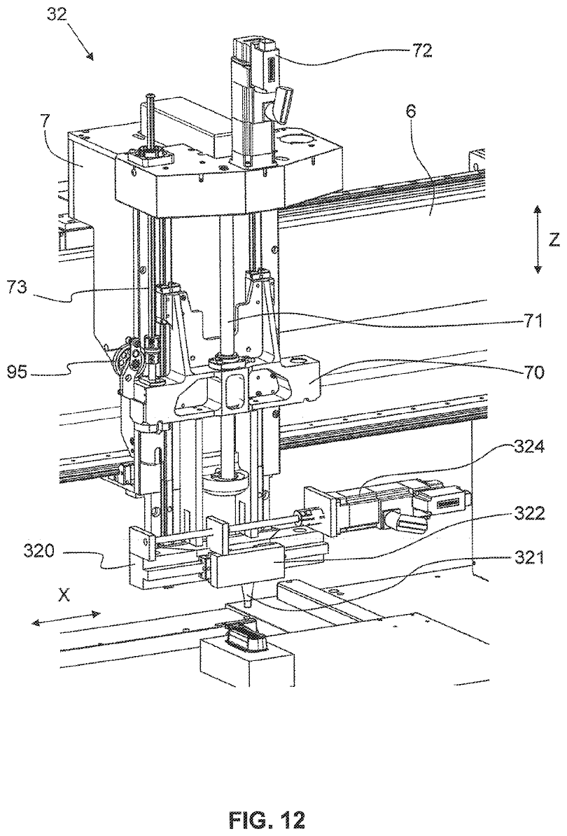

FIG. 12 shows a perspective view of an alternative second feed unit 32 for the linear winding technique for an individual coil former 42 to be wound. In contrast to the embodiment of FIG. 11, the drive of the horizontal slide 322 (second X axis) is realized by a spindle drive 324. Otherwise, the construction and the mode of operation of the components of this embodiment are identical to those of FIG. 11. The direct arrangement of the drive in the immediate vicinity of the horizontal slide 322 reduces the mass to be moved and therefore allows greater accelerations, which lead to shorter winding times.

FIG. 13 shows a perspective partial view of the winding machine 1 of FIG. 1 with a configuration for the linear winding technique for a plurality of coil formers 42 to be wound at the same time. In the illustrated exemplary embodiment, the second coil formers 42 to be wound are a plurality of teeth of an electric motor. These can be arranged and fastened individually on an alternative second receptacle 222 or they can be connected to one another, for example by a band. For practical reasons, the teeth are configured identically. However, they can also be designed differently from one another. The second receiving unit 22 is installed in the table area 11. The second receiving unit 22 has a second receiving carrier 220 which is displaceable in the second direction (Y axis) and is in the form of a table which is displaceable on rails and on which the alternative second receptacle 222 is arranged on the table 220 in this embodiment.

As in the embodiment of FIGS. 8 and 10, a gantry 6 with a slide 7 and a vertical slide 70 is arranged in the gantry region 12. In this embodiment, the slide 7 (X axis) is horizontally displaceable by means of gantry rails 60 and a drive 61, for example by a spindle drive. Alternative linear drives are likewise possible.

An alternative second feed unit 33, arranged on the vertical slide 70, with an alternative second feed carrier 330 with an alternative second feed 331 allows the simultaneous winding of three identical second coil formers 42 to be wound. In this case, the feed of the winding material 90 for the individual needles 331 is effected via the slide 7. The compensation arms 94 are arranged on the slide 7. Alternatively, the feed of the winding material could take place from the side, as in the exemplary embodiment of FIG. 8, at least for the outermost needles of the alternative second feeds 331. Alternatively, more than three coils 4 can be wound at the same time as one another.

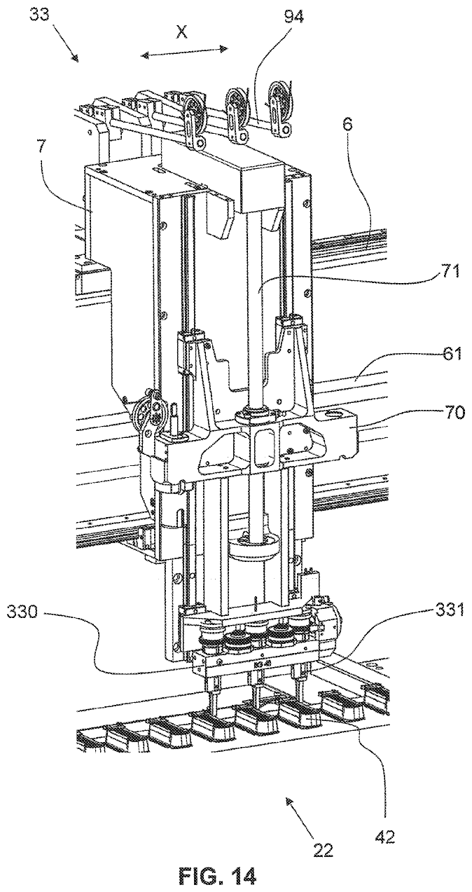

FIG. 14 shows a perspective view of the alternative second feed unit 33 of FIG. 13. As in the previous exemplary embodiments, the vertical slide 70 is moved by means of the spindle 71 and a drive (not illustrated). Since there is no space available for the drive on the slide 70, since this is required by the compensation arms 94, the drive for the vertical slide is arranged in the interior of the slide 7.

FIG. 15 shows a perspective view of an auxiliary unit 75. In the illustrated exemplary embodiment, the auxiliary unit 75 is a catching and cutting device for winding material. The auxiliary unit 75 has a base 750 with which the auxiliary unit 75 can be fastened to the slide 7. The auxiliary unit 75 is preferably fastened to the slide 7 on the underside of the slide 7, i.e. on its side directed towards the winding space 5.

A winding-material catching and cutting unit is arranged on the base 750 via adjusting units 751, 752, 753. A horizontal adjusting unit 751 (Y axis), a vertical adjusting unit 752 arranged thereon and a universal joint 753 allow a flexible and versatile positioning of the catching and cutting unit relative to the coil former to be wound. An auxiliary unit with a catching and cutting device is illustrated. It goes without saying that two or more of such units can be arranged on a common base. Alternatively, the adjusting units can also be arranged directly on the slide 7. Each catching and cutting unit has an actuator 754 with which a catching and cutting tool 755 can be actuated.

Other conventional auxiliary units can likewise be arranged on the gantry 6 or on the machine stand 10 in a similar manner.

For example, measuring or recognition devices can be used for recognizing particular positions of the coil formers 41, 42 to be wound. For example, optical (e.g. lasers) or mechanical (e.g. buttons) can be used for position recognition. Since the coil formers are conventionally composed of stacked sheets, it is sufficient if the precision of these measuring or recognition devices is in the range of the sheet thickness. Sheets with thicknesses of 0.3 to 0.5 millimeters are conventionally used. It is possible to achieve greater precision, but this generally increases the cost of the sensor technology required for this. This position recognition facilitates the setting-up of the machine and therefore speeds up the conversion from one coil former to be wound to the next. These recognition devices can be used for coil formers having a similar or identical construction to recognize manufacture-related differences automatically and compensate or correct them by means of the machine control.

### LIST OF REFERENCE SIGNS

| | |
|---|---|
| 1 | Winding machine |
| 10 | Machine stand |
| 100 | Cover |
| 11 | Table area |
| 12 | Gantry area |
| 13 | Parking area |
| 130 | Swivel table |
| 2 | Coil-former receptacle |
| 200 | First rail |
| 201 | Second rail |
| 21 | First receiving unit |
| 210 | First receiving carrier |
| 211 | First receptacle |
| 212 | Adapter |
| 22 | Second receiving unit |
| 220 | Second receiving carrier |
| 221 | Second receptacle |
| 222 | Alternative second receptacle |
| 3 | Winding material feed |
| 31 | First feed unit |
| 310 | First feed carrier |
| 311 | First feed |
| 32 | Second feed unit |
| 320 | Second feed carrier |
| 321 | Second feed |
| 322 | Horizontal slide |
| 323 | Belt drive |
| 324 | Drive |
| 33 | Alternative second feed unit |
| 330 | Alternative second feed carrier |
| 331 | Alternative second feed |
| 4 | Coil |
| 41 | First coil former |
| 42 | Second coil former |
| 5 | Receiving space |
| 6 | Gantry |
| 60 | Gantry rail |
| 61 | Drive |
| 62 | Opening |
| 7 | Slide |
| 70 | Vertical slide |
| 71 | Spindle |
| 72 | Drive |
| 73 | Profiled shaft |
| 75 | Auxiliary unit |
| 750 | Base |
| 751 | Horizontal adjusting unit |
| 752 | Vertical adjusting unit |
| 753 | Ball joint |
| 754 | Actuator |
| 755 | Catching and cutting tool |
| 8 | Control cabinet |
| 80 | Input unit |
| 81 | Button |
| 9 | Winding-material store |
| 90 | Winding material |
| 91 | Deflection cone |
| 92 | Brake roller |
| 93 | Sensor roller |
| 94 | Compensation arm |
| 95 | Deflection roller |
| 940 | Spring element |
| X | First direction |
| Y | Second direction |
| Z | Third direction |

1. A winding machine for winding at least one coil, comprising:
a machine stand having at least one coil-former receptacle, wherein the at least one coil-former receptacle provides a receiving space for at least one coil former to be wound, and
at least one winding-material feed, wherein the at least one winding-material feed is designed to feed winding material into the receiving space,
wherein the at least one coil-former receptacle comprises a set of at least one first receiving unit and at least one second receiving unit, wherein, in a first setting, using the first receiving unit, the winding machine allows winding of the at least one coil former to be wound in accordance with a first winding technique, and wherein, in a second setting, using the second receiving unit, the winding machine allows winding of the at least one coil former to be wound in accordance with a second winding technique, which is different from the first winding technique, wherein the first and second winding technique are selected from the group of winding techniques comprising the coil winding technique, the conventional needle winding technique, the linear winding technique and the flyer winding technique.

2. The winding machine as claimed in claim 1, wherein the first receiving unit has a first receiving carrier and a first receptacle arranged on the first receiving carrier of the at least one coil former to be wound, whereby the first coil former can be wound in accordance with the first winding technique and wherein the second receiving unit has a second receiving carrier and a second receptacle arranged on the second receiving carrier for receiving a second coil former of the at least one coil former to be wound, whereby the second coil former can be wound in accordance with the second winding technique.

3. The winding machine as claimed in claim 1, wherein the at least one winding-material feed has a set of at least one first feed unit and a second feed unit, wherein the winding machine is designed in such a way that, in the first setting of the winding machine, the first feed unit allows the winding of the at least one coil former in accordance with the first winding technique and, in the second setting of the winding machine, the second feed unit allows the winding of the at least one coil former in accordance with the second winding technique.

4. The winding machine as claimed in claim 3, wherein the first feed unit has a first feed carrier and a first feed arranged on the first feed carrier for feeding winding material, whereby the first coil former can be wound in accordance with the first winding technique and wherein the second feed unit has a second feed carrier and a second feed arranged on the second feed carrier for feeding winding material, whereby the second coil former can be wound in accordance with the second winding technique.

5. The winding machine as claimed in claim 1, wherein the at least one coil-former receptacle is at least one of non-releasably and non-displaceably and non-swivelably and non-rotatably arranged on the machine stand or wherein the at least one coil-former receptacle is at least one of releasably and displaceably and swivelably and rotatably arranged on the machine stand.

6. The winding machine as claimed in claim 1, wherein the machine stand has a table area, wherein the table area is designed for arranging the at least one coil-former receptacle and wherein the machine stand has a gantry area, wherein the gantry area is designed for arranging the at least one winding-material feed.

7. The winding machine as claimed in claim 6, wherein the gantry area has a gantry, wherein the gantry is arranged on the machine stand such that it is at least one of non-releasable and non-displaceable and non-swivelable and non-rotatable relative thereto, and wherein at least one slide is arranged on the gantry such that it is linearly displaceable in a first direction relative to the machine stand.

8. The winding machine as claimed in claim 7, wherein the at least one coil-former receptacle is arranged on the machine stand such that it is displaceable relative to a second direction relative to the said machine stand, wherein the second direction is formed at an angle relative to the first direction.

9. The winding machine as claimed in claim 1, wherein the at least one winding-material feed is at least one of non-releasably and non-displaceably and non-swivelably and non-rotatably arranged on the machine stand or wherein the at least one winding-material feed is at least one of releasably and displaceably and swivelably and rotatably arranged on the machine stand.

10. The winding machine as claimed in claim 7, wherein the at least one winding-material feed is arranged on at least one slide.

11. The winding machine as claimed in claim 8, wherein at least one of the first receptacle and the second receptacle is designed in such a way that it allows a rotation of the at least one coil former to be wound about an axis which is aligned in a third direction relative to the machine stand, wherein the third direction is formed at an angle relative to the first direction and the second direction.

12. The winding machine as claimed in claim 1, wherein the at least one coil-former receptacle is designed in such a way that one, two, three, four, five, six, seven, eight or more coil formers to be wound can be received at the same time.

13. The winding machine as claimed in claim 1, wherein the at least one winding-material feed is designed in such a way that one, two, three, four, five, six, seven, eight, nine, ten, eleven, twelve or more coil formers to be wound can be wound at the same time.

14. The winding machine as claimed in claim 11, wherein the first feed is displaceable in the first direction and is swivelable or rotatable relative to the third direction and wherein the first receptacle is displaceable relative to the second direction and is swivelable or rotatable relative to the third direction.

15. The winding machine as claimed in claim 11, wherein the second feed is displaceable in the first direction or wherein the second feed is displaceable in the first direction and swivelable or rotatable relative to the third direction and wherein the second receptacle is displaceable relative to the second direction.

16. The winding machine as claimed in claim 1, wherein the winding machine is a wire-winding machine.

17. The winding machine as claimed in claim 8, wherein the second direction is formed at a right angle relative to the first direction.

18. The winding machine as claimed in claim 11, wherein the third direction is formed at a right angle relative to the first direction and the second direction.
